(19) United States
(12) Patent Application Publication
(10) Pub. No.: US 2007/0075213 A1
(43) Pub. Date: Apr. 5, 2007

(54) Holding element for grating

(75) Inventors: Thomas Foser, Balzers (LI); Markus Durig, Gaschurn (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/518,343

(22) Filed: Sep. 8, 2006

(30) Foreign Application Priority Data
Sep. 22, 2005 (DE) 10 2005 000 123.8

(51) Int. Cl. A47B 96/06; F16M 13/00

(52) U.S. Cl. 248/547; 248/216.1

(57) ABSTRACT

A holding element for a grating has a first leg (11) at least one free end of which is hook-shaped and a second leg (12) having an attachment section (20) provided with a through-opening (23) for a fastening element (60). The first leg section includes a first leg section (14) carrying the hook-shaped end (13), a second leg section (15) along which the first leg section (14) is telescopically displaceable in a longitudinal direction (L) of the first leg (11), and a locking mechanism (30) provided between the first leg section (14) and the second leg section (15) for retaining the first leg section (14) on the second leg section (15).

### BACKGROUND OF THE INVENTION

1. Field of the Invention

The present invention relates to a holding element for a grating and having a first leg at least one free end of which is hook-shaped, and a second leg having an attachment section with a through-opening for a fastening element.

2. Description of the Prior Art

U.S. Pat. No. 5,118,147 discloses a holding element for a grating in which a hook-shaped first end engages a support, and on its second end remote from the hook-shaped first end, an engagement location for a screw is provided. The screw connects the holding element with a plate-shaped element abutting the grating and which, upon tightening, is secured to the support.

The drawback of the holding element of U.S. Pat. No. 5,118,147 consists in that it cannot be used without the plate-shaped element as a counter-support.

U.S. Pat. No. 4,703,883 discloses a holding element having two legs. The first leg has a U-shaped channel with an opening formed in the bottom of the channel for a fastening element. The second leg is flat and also has an opening. The holding element is secured on a constructional component with the first leg having the U-shaped channel. The fastening element is driven through the opening in the bottom of the U-shaped channel with a hand-held setting tool.

The drawback of the holding element of U.S. Pat. No. 4,703,883 consists in that the attachment of the grating on a support or a constructional component without auxiliary means that engages the grating, is not possible.

Accordingly, an object of the present invention is a holding element in which the drawbacks of the known holding elements are eliminated.

Another object of the present invention is a holding element that can be quickly secured with a setting tool.

### SUMMARY OF THE INVENTION

These and other objects of the present invention, which will become apparent hereinafter are achieved by providing a holding element of the type described above and in which the first leg has a first leg section carrying the hook-shaped end, a second leg section along which the first leg section is telescopically displaceable in a longitudinal direction of the first leg, and locking means provided between the first leg section and the second leg section for retaining the first leg section on the second leg section in a predetermined position.

The holding element according to the present invention can be rapidly secured on a support with a setting tool in a single operational step and, due to the telescopical displacement of the leg sections relative to each other, can be used for securing gratings with different heights. The locking means insures a fixed connection of the leg sections, and no additional auxiliary element(s) is (are) needed.

Advantageously, the second leg section has a guide with two guide grooves extending parallel to each other in the longitudinal direction of the first leg, and the first leg section has guide sections displaceable in the two guide grooves. In this way, a telescopic displacement of the two leg sections can be manually carried out in a simple manner because tilting of the two leg section with respect to each other is prevented.

Advantageously, the guide grooves are provided on opposite sides of the second leg section and are formed by flanged edges of the second leg section. With such a construction, the holding element can be formed of sheet metal that is subjected to stamping and bending.

Advantageously, the locking means includes a locking element and at least two counter-locking elements. With at least two counter-locking elements, the first leg section can be secured on the second leg section in at least two different positions corresponding to different lengths of the first leg in its longitudinal direction.

The locking element is formed preferably as a snap hook whereas the counter-locking elements are formed as locking webs. Thereby, there is provided a snap connection that can be formed in a simple manner, e.g., of sheet metal by stamping and bending.

Advantageously, the at least two counter-locking elements have, on their sides adjacent to the hook-shaped end, inclinations for lifting the locking element which is elastically displaceable. Thereby, the locking element or the snap hook, upon displacement of the first leg section relative to the second leg section, can be lifted off at each web against which the locking element is displaced and can pass by.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a perspective view of a holding element according to the present invention; and

FIG. 2 a cross-sectional view of the inventive holding element along line II-II in FIG. 1 in a mounted on a support, condition.

### DETAILED DESCRIPTION OF THE PREFERRED EMBODIMENT

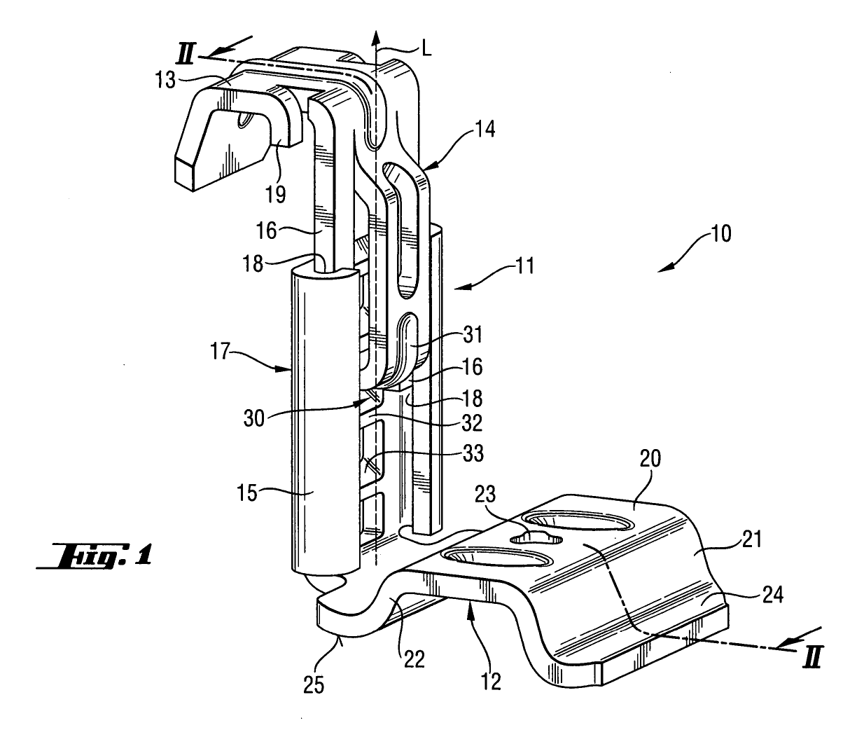

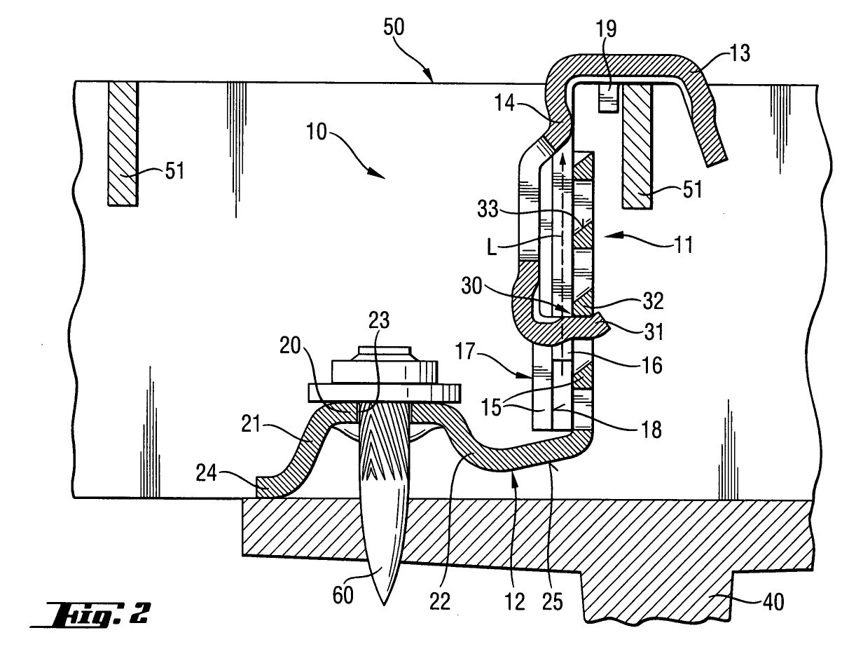

A fastening element 10 according to the present invention, which is shown in FIGS. 1-2, has a first leg 11 and a second leg 12 arranged approximately at a right angle relative to each other. The first leg 11 has a hook-shaped upper free end 13 for grasping a strut 51 of a grating 50 or any other element that need be attached to a support 40. The first leg 11 further has a first leg section 14 and a second leg section 15 along which the first leg section 14 is telescopically displaceable in a longitudinal direction L of the first leg 11. To this end, the second leg section 15 has a guide generally designated with a reference numeral 17 and formed of two guide grooves 18 provided on opposite sides of the second leg section 15 and extending in the longitudinal direction L. On the first leg section 14, there are provided guide sections 16 which are guided in respective guide grooves 17. The guide grooves 18 are formed by flanged edges of the second leg section 15.

Between the first leg section 14 and the second leg section 15, there is formed a locking mechanism 30 for securing the first leg section 14 relative to the second leg section 15. The locking mechanism 30 is formed as a snap lock having a locking element 31, which is formed as a snap hook and is provided on side of the first leg section 14, and a counter-locking element 32 which is formed as a locking bar and is provided on a side of the second leg section 15. In order to provide a plurality of locking positions corresponding to different lengths or heights of the first leg 11 in the longitudinal direction L, a plurality of counter-locking elements 32 are arranged one after another in the longitudinal direction L on the second leg section 15. On the sides of the counter-locking elements 32 adjacent to the hook-shaped end 13 of the first leg 11, there are formed inclinations 33 to provide for passing of the elastically bendable or swingable out locking element 31 upon insertion of the first leg section 14 into the second leg section 15. The separation of the two leg sections 14 and 15 is only possible by a manual pivotal movement of lifting of the snap hook-shaped locking element out/off its locking position in which it engages the counter-locking element 32.

Projections 19, which project form the hook-shaped end 13 in the direction of the second leg section 15, limit the region of the first leg section 14, which grasps the strut 51 of the grating 50, in a direction of the guide 17.

The second leg 12 forms a saddle-shaped attachment section 20 having a through-opening 23 for a fastening element 60 that can be driven with a setting tool, not shown in FIGS. 1-2, in a constructional component such as the support 40 shown in FIG. 2. The sides projecting from the attachment section form first and second foot sections 21, 22. The first foot section 21 is bent out at its end region 24 to form a region bearing against the constructional component. The second foot section 22 is likewise bent out at its end region remote from the attachment region 20, passing at this bent 25 directly into first leg 11 of the holding element 10.

Upon mounting, the holding element 10 is positioned with its hook-shaped end 13 grasping the strut 51 of the grating 50, while the attachment section 20 of the second leg 12 is positioned on the support 40. With a fastening element 60 set with a setting, e.g., combustion-engined tool, the holding element 10 is attached to the support 40. Finally, the first leg section 14 is pushed manually along the guide 17 into the second leg section 15 until the hook-shaped end 13 and the projections 19 grasp the strut 51. During the connection process, the locking element 31 elastically pivots over the inclination 33, sliding therealong. In its end position, the locking elements 31 lockingly engages the counter-locking element 32 (FIG. 2), and the grating 50 is reliably held only by the holding element 10 on the support 40.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A holding element for a grating comprising a first leg (11) at least one free end (13) of which is hook-shaped and having a first leg section (14) carrying the hook-shaped end (13), a second leg section (15) along which the first leg section (14) is telescopically displaceable in a longitudinal direction (L) of the first leg (11), and locking means (30) provided between the first leg section (14) and the second leg section (15) for retaining the first leg section (14) on the second leg section (15); and a second leg (12) having an attachment section (20) provided with a through-opening (23) for a fastening element (60).

2. A holding element according to claim 1, wherein the second leg section (15) has a guide (17) with two guide grooves (18) extending parallel to each other in the longitudinal direction (L) of the first leg (11), and the first leg section (14) has guide sections (16) displaceable in the two guide grooves (18).

3. A holding element according to claim 2, wherein the guide grooves (18) are provide on opposite sides of the second leg section (15) and are formed by flanged edges of the second leg section (15).

4. A holding element according to claim 1, wherein the locking means (30) comprises a locking element (31) and at least two counter-locking elements (32).

5. A holding element according to claim 4, wherein the locking element (31) is formed as a snap hook, and the at least two counter-locking elements (32) are formed as locking webs.

6. A holding element according to claim 4, wherein the at least two counter-locking elements (32) have, on sides thereof adjacent to the hook-shaped end (13), inclinations (33) for lifting the locking element (31) which is elastically displaceable.
